(19) United States
(12) Patent Application Publication
(10) Pub. No.: US 2012/0000991 A1
(43) Pub. Date: Jan. 5, 2012

(54) Spraying Apparatus And Agricultural Field Sprayer Having The Same

(76) Inventor: Peter Hloben, Koln (DE)

(21) Appl. No.: 13/000,082

(22) PCT Filed: Jun. 24, 2009
(86) PCT No.: PCT/EP2009/057906

§ 371 Date: May 4, 2011

(30) Foreign Application Priority Data
Jun. 27, 2008 (DE) 10 2008 002 739.1

(51) Int. Cl. B05B 1/20

(52) U.S. Cl. 239/159

(57) ABSTRACT

A spraying apparatus (19) for an agricultural field sprayer (10) having at least one spray line (32) disposed on the spraying boom (20), and a plurality of discharge openings (36) disposed along the spray line (32) connected by a part (38) to an inlet opening (66, 76) of a spray nozzle body (40, 70). Fluid flow from the inlet opening (44) to the nozzle body inlet opening (66, 76) is along a straight line fluid path. The connecting part (38) is configured as a valve housing. A ball (54) is responsive to a magnetic field generated by a coil (52,68) for movement away from a closed position located generally on the straight line fluid path to an open position offset from the path.

### FIELD OF THE INVENTION

The invention relates to a spraying apparatus for an agricultural field sprayer having a spraying boom, a spray line disposed on the spraying boom, and a plurality of discharge openings for spray liquid. The openings are disposed along the spray line and are respectively connected to an inlet opening of a spray nozzle body by way of a connecting part. This invention also relates to an agricultural field sprayer having such a spraying apparatus.

### BACKGROUND

Spraying apparatuses for agricultural field sprayers, in which a spray line is mounted on a foldable or hinged or retractable and extensible boom, are known. The boom is generally fastened to the frame of the vehicle and is transported over the ground, by means of the vehicle, for the application of spray liquid. The spray line has a plurality of discharge openings, which are provided with connecting bodies. The connecting bodies connect the spray line to a valve and a spray nozzle housing, and the spray liquid to be applied is routed from the spray line into the spray nozzle body by actuation of the valve. The spray nozzle body is equipped with one or more spray nozzles to ensure an appropriate atomization of the spray liquid during application. The connecting bodies, which are generally configured as a T-joint, are connected to the spray line on an upper connecting part having the respective discharge openings of the spray line. Lower connecting parts are connected to the spray nozzle bodies. A further connecting part, to which the valve controlling the flow of a spray liquid is connected, extends laterally. The spray liquid is thus first conducted from the upper connecting part into the lateral connecting part of the connecting body. From the lateral connecting part, the spray liquid flows into the valve body and into the spray nozzle body via the lower connecting part. Spraying apparatuses of this type are marketed, for example, by the company HYPRO, and may be equipped with pneumatically controlled stem-actuated valves, whereby a spring-loaded control piston, which correspondingly opens and closes a discharge opening in the valve, is moved pneumatically.

A further spraying apparatus of this type is disclosed in EP 0932448, which differs from the above-described spray apparatus by virtue of the fact that the control piston can be actuated electromagnetically. Both of these arrangements have the drawback that the spray liquid, as it flows through the connecting body or the valve, undergoes several changes of direction which leads to flow losses. In addition, the section through which the spray liquid passes, in particular the section from the discharge opening in the valve to the inlet into the spray nozzle body, is relatively long. Therefore, upon valve closure, considerable residue of spray liquid continues to flow after the closure, which can result in uncontrolled dripping in the application of the spray product. Furthermore, the valves which are used prove to be costly and complicated.

### SUMMARY

An object of the invention may be a spraying apparatus of the type stated in the introduction, by which one or more of the abovementioned problems may be overcome.

The object is achieved according to the invention by the teaching of patent claim 1 with further advantageous embodiments and refinements of the invention emerging from the claims dependent therefrom.

According to the invention, a spraying apparatus of the type stated in the above introduction is configured such that the connecting part is configured as a valve housing and has an inlet opening and an outlet opening for spray liquid. The outlet opening may be closed by a valve control structure. The inlet opening and the outlet opening of the connecting part are located opposite each other, and the direction of flow from the inlet opening to the outlet opening continues in the same direction to the inlet opening of the spray nozzle body. The fact that the connecting part is itself configured as a valve housing reduces the multiplicity of parts of the spraying apparatus. The two originally used components, namely a connecting part configured as a T-joint which connects the spray line and the spray nozzle body, and a valve housing which was fastened to the connecting part, are reduced to just one component. In addition, the path covered by the spray liquid from the discharge opening of the spray line to the inlet opening of the spray nozzle body is able to be made more compact. The fact that the inlet opening and the outlet opening of the connecting part configured as a valve housing are disposed opposite each other and the outlet opening is flowed through by the spray liquid in the same direction of flow as the inlet opening of the spray nozzle body enables the spray liquid, as it flows through the connecting part, to follow a direct path. Compared to a traditional connecting part configured as a T-joint wherein alternating directions of flow of the spray liquid occur, flow losses are reduced. Furthermore, a spraying apparatus according to the invention allows the outlet opening to be disposed in the direct vicinity of, or in comparison to traditional configurations having a T-joint, substantially closer to the inlet opening of the spray nozzle body. Residual flow of spray liquid is thereby virtually prevented when the outlet opening is closed by the valve control means since the distance or spacing between the outlet opening of the valve housing and the inlet opening of the spray nozzle body is minimized to minimize residual spray liquid present in the line portion between the outlet opening and the inlet opening of the spray nozzle body. The structure leads to a marked reduction in drip formation following closure of the outlet opening of the valve housing, since, in the traditional variant having a connecting part configured as a T-joint, the line portion configured between the outlet opening of the valve housing and the inlet opening of the spray nozzle body is substantially longer and thus contains significantly more residual spray liquid.

In one embodiment of the invention, the connecting part comprises an electromagnetic coil and the valve control means is configured as a magnetizable ball, that is, a ball made of or including material that may be attracted or repulsed by a magnetic field. The coil is configured and disposed such that, when the coil is electrically energized, the ball can be moved out of a closing position to an open position. In the closed position, the outlet opening is closed by the ball, and in the open position the ball may be moved transversely to the direction of flow of the spray liquid away from the outlet opening. The ball is arranged and dimensioned such that it covers or closes off the entire flow cross section of the outlet opening of the connecting part configured as a valve housing. Therefore, when pressure is applied to the spraying apparatus, the ball is forced into the outlet opening by the pressure difference between the inlet opening and the outlet opening to close the outlet opening. By electrically energizing the coil, a magnetic flux and thus a magnetic force can be generated which moves the magnetizable ball out of its seat. When the electrical energization of the coil is terminated, the ball is automatically forced back into the outlet opening due to the abovementioned hydraulic pressure difference. The connecting part configured as a valve housing, together with the coil and the valve control means configured as a ball, thus constitutes a type of ball valve, the seat of the ball constituting a valve seat configured on the outlet opening. An appropriate layout, geometry, positioning and orientation of the coil enables the generated magnetic force acting upon the ball to be orientated such that the ball is moved laterally or transversely to the direction of flow.

The connecting part may be configured as a hollow body, with the coil being configured over an entire peripheral region of the hollow body such that the rotational axis of symmetry of the coil points in the direction of flow of the spray liquid and the ball is located inside the coil. The hollow body can be configured, for example, as a tube or hollow cylinder having an inlet opening and an outlet opening, the outlet opening being blockable by a ball mounted in the hollow cylinder. The tube or hollow cylinder is surrounded on its periphery by the coil having a winding of configured on or in the wall of the tube or hollow cylinder. The winding is encased by a magnetizable material. A non-magnetizable region in this casing, or an opening or interruption of the casing, is provided from which the magnetic field lines generated upon energization of the coil can emerge or enter and exert a magnetic force on the ball mounted inside the tube or hollow cylinder. By appropriate shaping of the winding and of the non-magnetizable region on the casing of the winding (or of the interruption or opening on the casing of the winding), the direction of action of the generated magnetic force can be varied, so that the magnetic force is able to move the ball out of its seat in a direction transversely to the outlet opening of the tube or hollow cylinder.

In an alternative embodiment of the invention, the connecting part is configured as a hollow body and the coil is configured in or on a region of the wall of the hollow body such that the rotational axis of symmetry of the coil points transversely to the direction of flow of the spray liquid and the ball is located outside the coil. The hollow body may be configured, for example, as a tube or hollow cylinder having an inlet opening and an outlet opening, the outlet opening being blockable by a ball mounted in the hollow cylinder. The tube or hollow cylinder can be formed of a non-ferromagnetic metal with an electromagnetic coil being embedded or incorporated, for example, in the wall of the hollow cylinder, level with the ball seat. The electromagnetic coil when energized exerts a corresponding magnetic force on the ball and moves this out of its seat in a direction transversely to the outlet opening of the tube.

The connecting part may be connected to the spray line directly at the discharge opening of the spray line. The connecting part configured as a tube or hollow cylinder, or the valve housing configured as a tube or hollow cylinder, can thus be directly fastened with its inlet opening to the discharge opening of the spray line, for example by a screw thread, by a plug connection, by bonding, or by a bayonet fastening.

The connecting part is connected directly at its outlet opening to the inlet opening of the spray nozzle body. A connecting part configured as a tube or hollow cylinder, or the valve housing configured as a tube or hollow cylinder, can thus connect to the inlet opening of the spray nozzle body, for example by a screw thread, by a plug connection, by bonding, or by a bayonet fastening. By virtue of the fact that the outlet opening of the connecting part and the inlet opening of the spray nozzle body lie as close together as possible, the quantity of spray liquid which, upon closure of the connecting region configured as a valve housing, afterflows into the spray nozzle body is able to be reduced or minimized. The spray nozzle body can here be formed as a traditional spray nozzle body with or without a spray nozzle carousel for nozzle selection.

In an embodiment of the invention, the spraying apparatus is configured such that the direction of flow of the spray liquid through the discharge opening of the spray line, through the inlet opening of the connecting part, through the outlet opening of the connecting part and through the inlet opening of the spray nozzle body is the same or remains constant so that the flow of the spray liquid from the discharge opening of the spray line into the inlet opening of the spray nozzle body can be realized without significant changes of direction. The connecting part configured as a valve housing can be configured, for example, as a tubular or hollow cylinder having opposing inlet and outlet openings, the inlet opening lying in alignment with the discharge opening of the spray line and the outlet opening lying in alignment with the inlet opening of the spray nozzle body, so that, as far as possible, rectilinear flow of spray liquid is ensured. Flow losses generated by changes of flow direction can hence be avoided or minimized.

In one embodiment of the invention, an agricultural field sprayer, equipped with a spraying apparatus according to the above description, is provided and has a plurality of discharge openings and a plurality of connecting parts configured as valve bodies connected to a corresponding plurality of spray nozzle bodies.

It is of particular advantage that, as a result of the arrangement according to the invention compared with traditional electrically or pneumatically controlled valve devices with T-joint-like connecting pieces, the distance between a discharge opening on the spray line and the inlet opening of a spray nozzle body can be significantly reduced, whereby a fall in pressure in the spray liquid in this region is reduced, enabling the spray liquid to be applied in a more effective, precise and uniform manner. As a result of the ball-valve-like configuration of the connecting part configured as a valve body, any potential for blockage of the valve body is further minimized, since the movement of the ball has a self-cleaning effect.

The invention, and further advantages and advantageous refinements and embodiments of the invention, are described and explained in greater detail below with reference to the drawing, which shows two illustrative embodiments of the invention.

### BRIEF DESCRIPTION OF THE DRAWINGS

FIG. 1 shows a schematic side view of an agricultural field sprayer having a spraying apparatus according to the invention,

FIG. 2 shows an enlarged cross-sectional view of a connecting part of the spraying arrangement from FIG. 1 in a first illustrative embodiment,

FIG. 3 shows an enlarged cross-sectional view of a connecting part of the spraying arrangement from FIG. 1 in a second illustrative embodiment, and

FIG. 4 shows an enlarged cross-sectional view of the connecting part of the spraying arrangement according to FIG. 3, with a spray nozzle body having a spray nozzle carousel.

### DETAILED DESCRIPTION

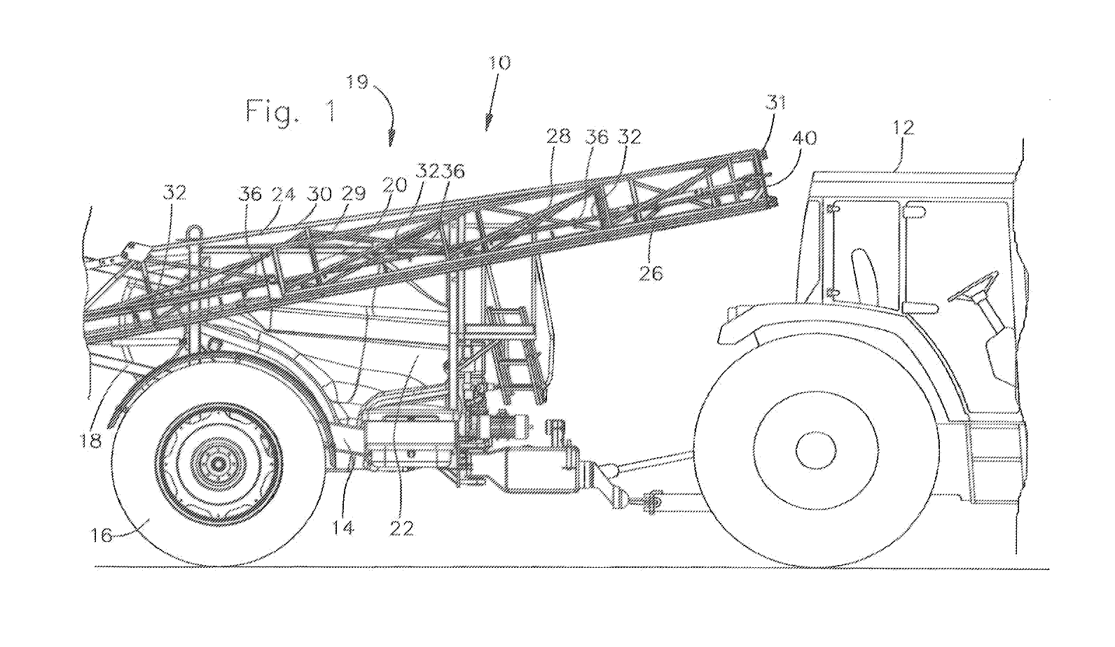

FIG. 1 shows an agricultural sprayer 10 in the form of a trailer sprayer towed by a tractor 12. The sprayer 10 has a frame 14 with wheels 16. Fitted to the frame 14 is a parallelogram linkage 18, to which a spraying apparatus 19 is connected. The spraying apparatus 19 comprises a spraying boom 20. In addition, the sprayer 10 is provided with a tank 22 fitted to the frame 14.

The spraying boom 20 has top and bottom members 24, 26, which are connected to each other by numerous diagonal members 28 and form a framework. The spraying boom 20 is made up of a plurality of segments 29, 30, which are connected to each other by hinges 31 and extend on both sides of the sprayer 10. As a result of the hinges 31, the spraying boom 20 can be collapsed into a transport position (as represented in FIG. 1) or into an operating position.

The spraying boom 20 is provided with spray lines 32 which extend on both sides of the sprayer 10 along the spraying boom 20. The spray lines 32 are configured at least partially as tubes, which are provided with discharge openings 36. The spray lines 32 are connected to supply and return hoses (not shown), by which a spray liquid to be sprayed is conducted from the tank 22 into the spray line 32, or non-applied (unsprayed) spray liquid is conducted in a recirculating manner from the spray line 32 back to the tank 22.

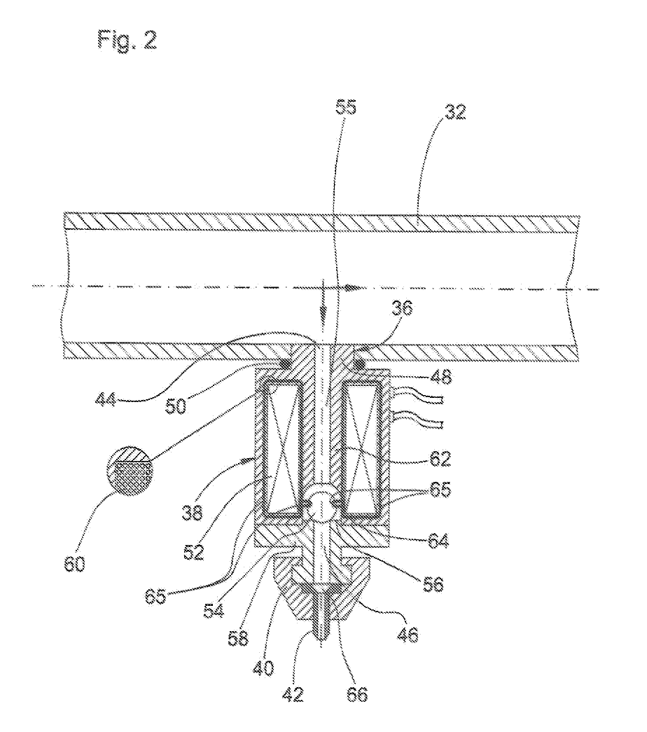

In one embodiment of the spraying apparatus 19 illustrated in FIG. 2, the discharge openings 36 of the spray line 32 are provided with a connecting part 38 and a spray nozzle body 40 connected to the connecting part 38. The spray nozzle body 40 is further equipped with a spray nozzle 42.

The connecting part 38 comprises an inlet opening 44, an outlet opening 46, and a mounting flange 48, which is sealed off by means of an O-ring 50. The connecting part 38 further comprises an electromagnetic coil 52. Inside the connecting part 38 there is disposed a magnetizable ball 54, which blocks the outlet opening 46. The connecting part is shown as being configured in a rotationally symmetric manner as a tube or as a hollow cylinder. In a cavity 55 of the connecting part 38, a step surface 56 is provided between the inlet opening 44 and the outlet opening 46. The ball 54, the outlet opening 46, the step surface 56 and the inlet opening 44 are dimensioned or coordinated such that, on the one hand, the diameter of the ball 54 is larger than the diameter of the outlet opening 46 and, on the other hand, the step surface 56 is large enough to enable the ball 54 to be mounted thereon without blocking the outlet opening 46 once the outlet opening 46 is cleared of the ball 54. The lower region of the connecting part 38 is configured as a mounting flange 58, to which the spray nozzle body 40 is fastened, the step surface 56 being configured on that side of the mounting flange 58 which is facing the cavity 55. The coil 52 has a wire winding 60 and a magnetizable casing 62 of the wire winding 60, the casing 62 having a non-magnetizable region 64 or an opening or interruption of the casing 62 for the issue of magnetic field lines 65. The coil 52 is configured as a sleeve or tube, so that it is pushed with its cavity over the outer surface of the connecting part 38. The non-magnetizable region 64 of the casing 62 is here orientated such that it lies level with the ball 54, so that the magnetic field lines 65 which, when the coil 52 is energized, emerge from the non-magnetizable region exert a magnetic force which is directly transmitted to the ball. Through energization of the coil 52, the ball is then moved to the side by means of the generated magnetic force, i.e. perpendicularly to the direction of flow of the spray liquid flowing through the connecting part 38, so the outlet opening 46 is cleared.

The inlet opening 44 and the outlet opening 46 are arranged such that they flow passes therebetween in a same direction. The cavity 55 inside the connecting part 38, which is accessible through the inlet opening 44, passes directly into the outlet opening 46 so that no further partitions are provided so that, as far as possible, direct flow of fluid occurs without changes of direction. The spray nozzle body 40 has an inlet opening 66, which directly connects to the outlet opening 46 of the connecting part 38 in the region of the mounting flange 58, the same direction of flow being maintained here also. The spray nozzle body 40 is in this case configured as a single-nozzle body, having just one exchangeable spray nozzle 42.

The coil can be energized on a frequency-dependent basis by a programmed electronic control unit (not shown), so that, in the presence of a voltage, a magnetic field is generated, by which the ball 54 is moved to the side onto the annular surface of the step 56, and, in the absence of a voltage, the magnetic field is deactivated, so that the ball is forced by the through-passing spray liquid into its ball seat. In other words, the ball is pressed into the outlet opening 46 to block flow. Through appropriate clocked or frequented or pulsed or pulse-width modulated energization of the coil, an opening and closing of the outlet opening 46 can be precisely controlled. The connecting part 38 thus constitutes a valve body comprising a valve control means configured as a ball 54. The ball 54 and the outlet opening 46 disposed in the connecting part 38 or in the valve body, defines a ball valve which can be controlled or opened electromagnetically by energization of the coil 52. Advantageously, due to the compact configuration of the connecting part 38, a very short spacing between the outlet opening 46 of the connecting part 38 and the inlet opening 66 of the spray nozzle body 40 is realized, whereby the residual or afterflow of spray liquid present between the outlet opening 46 and the inlet opening 66, and thus also a drip formation on the spray nozzle 42, occurring upon closure of the valve body, is minimized or reduced.

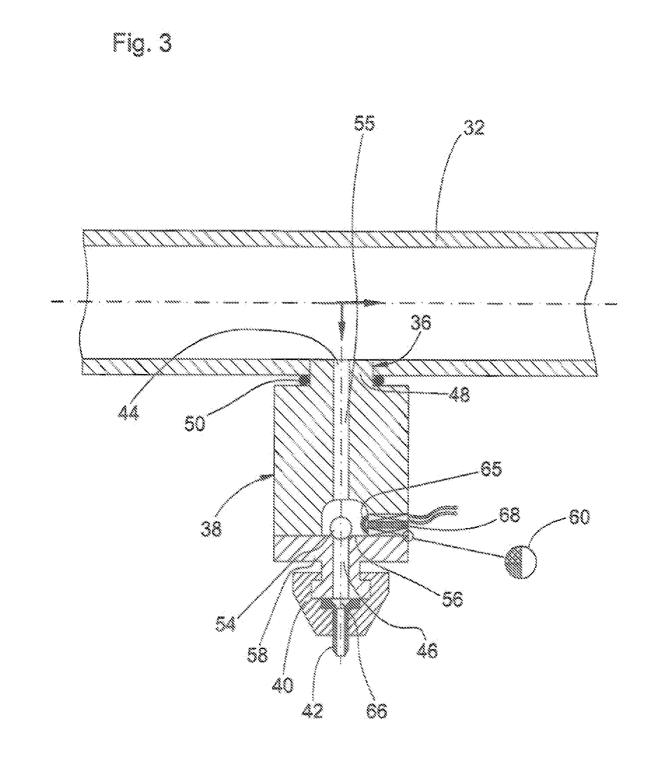

An alternative embodiment represented in FIG. 3 is similar to the embodiment represented in FIG. 2 but includes a different type and arrangement of the coil 68 which magnetizes the ball 54. The coil 68 of the FIG. 3 embodiment is configured as a traditional electromagnetic coil 68 without magnetizable casing 62. The coil 68 is level with the ball 54 and is flush-mounted into the wall of the connecting part 38. The coil diameter is relatively small compared that of the embodiment shown in FIG. 2. The magnetic force generated by energization of the coil 68 acts longitudinally to the coil axis. Through appropriate geometric configuration of the coil 68 with respect to diameter, length, number of windings and coil wire thickness, various magnetizations, and thus variously high magnetic forces, can be obtained. The energization of the coil 68 is realized in the same way as in the illustrative embodiment represented in FIG. 2. All other details and particulars apply correspondingly according to the embodiment described above in relation to FIG. 2.

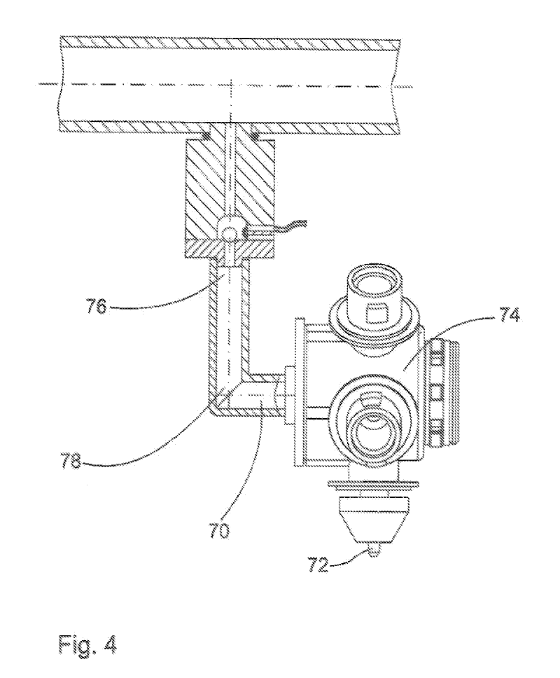

Even though the invention has been described on the basis of several illustrative embodiments, in the light of the above description and the drawing many other diverse alternatives, modifications and variants which fall under the present invention will be revealed to the person skilled in the art. For instance, in a further embodiment as represented in FIG. 4, in place of a single-nozzle body, a spray nozzle body 70 having a plurality of spray nozzles 72 can be connected. The spray nozzles are in this case disposed on a spray nozzle carousel 74, which is arranged such that it can be twisted in relation to an inlet duct 78 connected to an inlet opening 76, so that, through twisting of the carousel 74, different spray nozzles 72 can be selected for application of the spray liquid. A spray nozzle body 70 of this type, which is commonly known in the prior art, can be used both in the embodiment described in relation to FIG. 2 and in that described in relation to FIG. 3.

1. A spraying apparatus for an agricultural field sprayer, having a spraying boom, at least one spray line disposed on the spraying boom, and a plurality of discharge openings for spray liquid, which openings are disposed along the spray line and are respectively connected to an inlet opening of a spray nozzle body by way of a connecting part, wherein the connecting part is configured as a valve housing and has an inlet opening and an outlet opening for spray liquid, which latter opening can be closed by a valve control means, the inlet opening and the outlet opening of the connecting part being disposed opposite each other, and the outlet opening being flowed through by the spray liquid in the same direction of flow as the inlet opening of the spray nozzle body.

2. The spraying apparatus as claimed in claim 1, wherein the connecting part comprises an electromagnetic coil and the valve control means is configured as a magnetizable ball, the coil being configured and disposed such that, when the coil is acted upon electromagnetically, the ball can be moved out of a closing position, in which the outlet opening is kept closed by the ball, into an opening position, the movement of the ball being effected transversely to the direction of flow of the spray liquid.

3. The spraying apparatus as claimed in claim 2, wherein the connecting part is configured as a hollow body, the coil being configured over an entire peripheral region of the hollow body such that the rotational axis of symmetry of the coil points in the direction of flow of the spray liquid and the ball is located inside the coil.

4. The spraying apparatus as claimed in claim 2, wherein the connecting part is configured as a hollow body, the coil being configured in or on a region of the wall of the hollow body such that the rotational axis of symmetry of the coil points transversely to the direction of flow of the spray liquid and the ball is located outside the coil.

5. The spraying apparatus as claimed in claim 1, wherein the connecting part is connected to the spray line directly at the discharge opening of the spray line.

6. The spraying apparatus as claimed in claim 1, wherein the connecting part is connected directly at its outlet opening to the inlet opening of the spray nozzle body.

7. The spraying apparatus as claimed in claim 1, wherein the direction of flow of the spray liquid through the discharge opening of the spray line, through the inlet opening of the connecting part, through the outlet opening of the connecting part and through the inlet opening of the spray nozzle body is the same, so that the flow of the spray liquid from the discharge opening of the spray line into the inlet opening of the spray nozzle body can be realized without changes of direction.

8. An agricultural field sprayer having a spraying apparatus as claimed in claim 1.

9. A spraying apparatus for an agricultural field sprayer, having a spraying boom, at least one spray line disposed on the spraying boom, and a plurality of discharge openings for spray liquid, which openings are disposed along the spray line and are respectively connected to an inlet opening of a spray nozzle body by way of a connecting part, wherein the connecting part is configured as a valve housing and has an inlet opening and an outlet opening for spray liquid, a valve control for controlling flow between the inlet opening and the outlet opening, the inlet opening and the outlet opening being disposed opposite each other and generally lying along a straight line fluid path extending from the inlet opening to the inlet opening of the spray nozzle body, wherein the connecting part comprises an energizable electromagnetic coil and the valve control comprises a ball responsive to a magnetic field generated by the coil for movement to and away from the straight line fluid path between an open position and a closed position, the coil being configured and disposed such that, when the coil is energized the ball moves from the closed position towards the open position.

10. The spraying apparatus as claimed in claim 9, wherein the movement of the ball is transverse to the straight line fluid path.

11. The spraying apparatus as claimed in claim 9, wherein the connecting part is configured as a hollow body, the coil being configured over an entire peripheral region of the hollow body such that the rotational axis of symmetry of the coil points in the direction of flow of the spray liquid and the ball is located inside the coil.

12. The spraying apparatus as claimed in claim 9, wherein the connecting part is configured as a hollow body, the coil being configured in or on a region of the wall of the hollow body such that the rotational axis of symmetry of the coil points transversely to the direction of flow of the spray liquid and the ball is located outside the coil.

13. The spraying apparatus as claimed in claim 9, wherein the connecting part is connected to the spray line directly at the discharge opening of the spray line.

14. The spraying apparatus as claimed in claim 9, wherein the connecting part is connected directly at its outlet opening to the inlet opening of the spray nozzle body.

15. The spraying apparatus as claimed in claim 9, wherein the direction of flow of the spray liquid through the discharge opening of the spray line, through the inlet opening of the connecting part, through the outlet opening of the connecting part and through the inlet opening of the spray nozzle body is the same, so that the flow of the spray liquid from the discharge opening of the spray line into the inlet opening of the spray nozzle body can be realized without changes of direction.

16. The spraying apparatus as claimed in claim 9, wherein the ball is movable between a first position on the outlet opening corresponding to the closed position and a second position to one side of the straight line fluid path corresponding to the open position.

17. The spraying apparatus as claimed in claim 9, wherein the coil comprises one of the following:
a frequency modulated coil;
a pulse-width modulated coil; and
a pulsed coil for precise movement of the ball to and away from the straight line fluid path.
